(19) United States
(12) Patent Application Publication
(10) Pub. No.: US 2026/0318792 A1
(43) Pub. Date: Oct. 15, 2026

(54) NON-DESTRUCTIVE ANTIGEN RETRIEVAL METHOD WITH MILD CONDITIONS FOR 3D HISTOLOGY

(71) Applicant: The Chinese University of Hong Kong, Hong Kong (CN)

(72) Inventors: Hei Ming LAI, Hong Kong (CN); Lichun ZHANG, Hong Kong (CN)

(21) Appl. No.: 19/645,423

(22) Filed: Apr. 13, 2026

Related U.S. Application Data
(60) Provisional application No. 63/787,230, filed on Apr. 11, 2025.

(51) Int. Cl. G01N 1/34; C11D 1/92; C11D 3/04; G01N 1/30; G01N 1/44

(52) U.S. Cl. CPC G01N 1/34; C11D 1/92; C11D 3/04; G01N 1/30; G01N 1/44

(57) ABSTRACT

A novel method for antigen retrieval from formalin-fixed paraffin embedded (FFPE) tissue samples for 3D IHC. The method uses an aqueous chemical solution for antigen retrieval containing a detergent and a chaotropic agent. The detergent includes a zwitterionic species and the chaotropic agent includes a water-soluble boron cluster compound. The method allows to treat a tissue sample with the aqueous chemical solution under mild heating for optimal antigen retrieval for subsequent 3D IHC.

### CROSS-REFERENCE TO RELATED APPLICATION

The present application claims the benefit of U.S. Provisional Application Ser. No. 63/787,230, filed Apr. 11, 2025, which is hereby incorporated by reference herein in its entirety, including any figures, tables, or drawings.

### BACKGROUND OF THE INVENTION

Antigen retrieval has greatly impacted histology research worldwide over its 30 years of development and has transformed traditional section-based 2D histology [1,2]. Antigen retrieval allows reliable immunohistochemistry (IHC) to be performed on archived samples, primarily on tissues stored in formalin-fixed, paraffin-embedded (FFPE) tissue blocks. IHC allows the visualization of specific biomolecules called antigens within the tissues, the morphology and location of which is crucial for understanding the tissue biology, for diagnostic accuracy, for disease classification, and for therapeutic decision making based on the detected biomarkers.

Moreover, IHC is preferably applied to FFPE sections, resulting in superior morphology, due to the thinness of the slices, thus enabling a high-resolution view of the tissue embedded by this method. Furthermore, FFPE is the most preferred method for tissue storage, as the tissue is desiccated and fixed in a solid block, maintaining stability at room temperature, obviating the need for refrigeration, and avoiding hazardous or spillage concerns during storage and transport.

Hence, the development of reliable antigen retrieval techniques has resulted in great interest for applying IHC to FFPE sections. As implied by its name, antigen retrieval enables tissue antigens to be recovered for detectability by using IHC. Histological analysis of FFPE sections without antigen retrieval leads to poor IHC signal and nonspecific staining, resulting in low quality slides and images that are unsuitable for tissue diagnostics. Instead, by utilizing antigen retrieval-assisted IHC, pathologists can directly visualize the spatial distribution and location of different antigens in archived or freshly prepared FFPE sections, which provide the best morphology quality that is essential for diagnostics. This approach has led to a billion-dollar industry that utilizes antigen retrieval-assisted IHC daily in every standard histopathological diagnostic laboratory. Antigen retrieval-assisted IHC for detecting tissue biomarkers is now the standard of care for all cancers and other diseases. Despite the great success obtained by 2D histology, little progress has been made in the field of 3D analysis of histological samples. 3D histology provides the ground truth view of tissue morphology and cellular distributions. However, deeply penetrating IHC is unreliable for archived samples stored in paraffin wax. Antigen retrieval for paraffin wax sections in conventional 2D histology has been transformative but the methods cannot be extrapolated to 3D histology. Accordingly, a new reliable antigen retrieval method for 3D histology is crucially needed for retrospective and future studies of 3D histology samples [3].

### BRIEF SUMMARY OF THE INVENTION

Disclosed herein is a method for antigen retrieval from FFPE tissue blocks for 3D IHC. In embodiments, the method comprises deparaffinizing, washing, rehydrating the tissue, and applying an aqueous chemical solution under mild conditions (less than about 80° C.) for a period of time ranging from about 10 minutes to about 2 weeks, depending on the specific properties of the sample.

In certain embodiments, the paraffin wax is first removed from the tissue utilizing an organic solvent A. The tissue is then washed with an organic solvent B to wash out the organic solvent A and dissolved paraffin wax. Next, the tissue is rehydrated with a series of washes in methanol-water solutions with an increasing proportion of water. Finally, the aqueous chemical solution is applied to the tissue for antigen retrieval before proceeding to 3D IHC.

In certain embodiments, the aqueous chemical solution comprises a surfactant and a chaotrope. In some examples, the surfactant comprises a zwitterionic species, such as an alkylated sulfobetaine. In a preferred embodiment, the alkylated sulfobetaine is N-hexadecyl-N,N-dimethyl-3-ammonio-1-propanesulfonate. In certain embodiments, the chaotrope is a water-soluble boron cluster compound. In preferred embodiments, the boron cluster compound is a dodecahydro-closo-dodecaborate ion.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates antigen retrieval in tissues from a batch of formalin-fixed human colon. The upper row (Ctrl) has not been embedded in paraffin and proceeded directly to 3D IHC, while the lower two rows have undergone the FFPE process. The 2^{nd} row has not been antigen retrieved, while the 3^{rd} row has been antigen retrieved following the instant method. In red are shown 3D indirect IHC using rabbit anti-NaK-ATPase antibodies. In green are shown cells labelled with lectin using wheat germ agglutinin. The Merge column shows the overlap of the two stainings.

FIG. 2 illustrates the effect of adding a chaotrope to a detergent with mild heating antigen retrieval at 55° C. Vimentin staining (magenta) shows substantially less nonspecific staining.

FIG. 3 shows a close-up view of the improved staining quality with the addition of dodecaborate in antigen retrieval. Experimental replicates are shown.

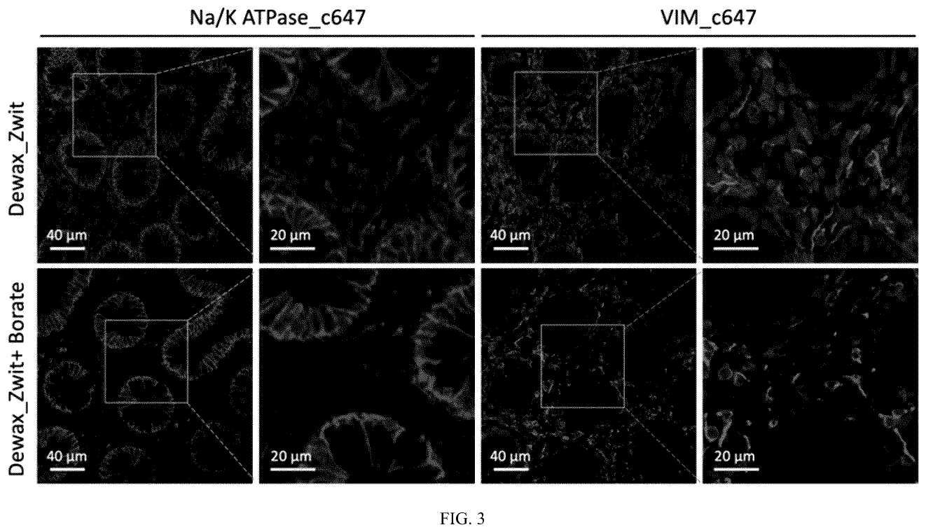

### DETAILED DISCLOSURE OF THE INVENTION

### Selected Definitions

As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. The transitional terms/phrases (and any grammatical variations thereof) “comprising”, “comprises”, “comprise”, “consisting essentially of”, “consists essentially of”, “consisting” and “consists” can be used interchangeably.

The phrases “consisting essentially of” or “consists essentially of” indicate that the claim encompasses embodiments containing the specified materials or steps and those that do not materially affect the basic and novel characteristic(s) of the claim.

The term “about” means within an acceptable error range for the particular value as determined by one of ordinary skill in the art, which depends in part on how the value is measured, i.e., the limitations of the measurement system. In the context of compositions containing amounts of ingredients where the term “about” is used, these compositions contain the stated amount of the ingredient with a variation (error range) of 0-10% around the value (X±10%). In other contexts, the term “about” is providing a variation (error range) of 0-10% around a given value (X±10%). As is apparent, this variation represents a range that is up to 10% above or below a given value, for example, X±1%, X±2%, X±3%, X±4%, X±5%, X=6%, X±7%, X±8%, X±9%, or X=10%.

In the present disclosure, ranges are stated in shorthand to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc. Values having at least two significant digits within a range are envisioned, for example, a range of 5-10 indicates all the values between 5.0 and 10.0 as well as between 5.00 and 10.00 including the terminal values. When ranges are used herein, combinations and subcombinations of ranges (e.g., subranges within the disclosed range) and specific embodiments therein are explicitly included.

By “reduces” is meant a negative alteration of at least 1%, 5%, 10%, 25%, 50%, 75%, or 100%.

By “increases” is meant as a positive alteration of at least 1%, 5%, 10%, 25%, 50%, 75%, or 100%.

As used herein, the terms “determining,” “measuring,” and “assessing,” and “assaying” are used interchangeably and include both quantitative and qualitative determinations.

### Methods for Antigen Retrieval for 3D IHC

The subject invention pertains to a method for antigen retrieval applicable to FFPE tissue blocks for subsequent 3D IHC. In one aspect the method comprises the following main steps:
1. Deparaffinization of the tissue using an organic solvent A to dissolve the paraffin wax and extract it from the tissue matrix;
2. transitional washing of the tissue to remove the organic solvent B and the dissolved wax and avoid re-deposition of wax into the tissue;
3. rehydration of the tissue with graded solvents that transition the tissue from a dehydrated state to a hydrated state;
4. antigen retrieval in the tissue using an aqueous solution comprising a surfactant and a chaotrope with mild heating for recovering protein antigen epitopes; and
5. proceeding to subsequent 3D IHC of the tissue.

In preferred embodiments, the size of the tissue block should not be larger than about 3 cm×about 3 cm×about 5 mm. In certain embodiments, the size of the tissue block may exceed the size of about 3 cm×about 3 cm×about 5 mm by about 1%, 2%, 3%, 4%, 5%, 6%, 7%, 8%, 9%, 10%, 11%, 12%, 13%, 14%, 15%, 16%, 17%, 18%, 19%, 20% or more for each or for all of its dimensions.

In embodiments, the deparaffinization step quickly and completely dissolves the wax embedded in the tissue using an organic solvent A. In certain embodiments, the organic solvent A includes, but is not limited to, xylene, toluene, limonene. In preferred embodiments, the organic solvent A comprises alkanes with low boiling points. In some embodiments, the organic solvent A comprises saturated linear alkanes and saturated cyclic alkanes, or their mixtures, with a boiling point above 37° C. In more preferred embodiments, the organic solvent A includes saturated cyclic alkanes. In more preferred embodiments, the organic solvent A is cyclohexane or methylcyclopentane.

In embodiments, the transitional washing step utilizes an organic solvent B, i.e., a solvent mixture miscible with both the deparaffinization organic solvent A and the subsequent graded solvent for rehydration. Paraffin wax is extracted effectively from the tissue with this solvent mixture. In certain embodiments, solvent B includes, but is not limited to, a mixture of tetrahydrofuran and methanol or, alternatively, ethers, ketones, or alcohols with alkyl and aromatic side chains. In preferred embodiments, solvent B includes a mixture of tetrahydrofuran and methanol.

In embodiments, the rehydration step comprises exchanging the tissue in a series of solutions having an increasing proportion of water. In certain embodiments, the solutions include, but are not limited to, methanol-water mixtures with decreasing concentrations of methanol. Optionally, in certain embodiments, soluble additives may be added to facilitate the rehydration of the tissue, such as a surfactant S, organic and inorganic salts, acid and base-controlling agents, or other organic solvents. In certain examples, the surfactant S includes, but is not limited to, a zwitterionic surfactant, non-ionic surfactant, anionic surfactant, or cationic surfactant.

In embodiments, the antigen retrieval step comprises applying an aqueous detergent solution comprising a surfactant and a chaotropic agent to the tissue to facilitate the refolding of proteins globally throughout the tissue. Without being bound to any theory, formalin crosslinking reversal is auxiliary but not sufficient for the purpose of retrieving antigens for IHC. Due to wax embedding, the tissue changes from a hydrated state to a hydrophobic matrix-embedded state. This causes most of the proteins to fold “inside-out” where the normally buried hydrophobic residues are now exposed and the hydrophilic residues that usually are the targets of antibody binding are now buried. Hence, the heat treatment or protease digestion in 2D histology facilitates the reversal of the protein refolding process in an aqueous environment, with lower energy barriers to refolding if formalin crosslinking is removed or digested by proteases. In such a case, a surfactant in the presence of a chaotrope may perform the same thermodynamic facilitation in the refolding of hydrophobic-exposed proteins. In certain embodiments, additional optional additives, such as water-miscible organic solvents, salts, pH buffering agents, and ion-chelating agents, and cyclodextrins may further help this process.

In certain embodiments, a surfactant comprises an alkylated sulfobetaine reagent coupled with a closo-dodecaborate ion ([B₁₂H₁₂]²⁻) as the chaotropic agent. In preferred embodiments, the general structure of the surfactant of formula 1 is:

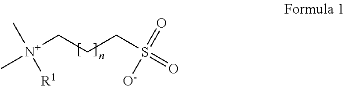

where n ranges from 0 to 10, where R¹ is independently selected from the group consisting of a linear alkyl, branched alkyl, cyclic alkyl, steroid-containing group, and aromatic-containing alkyl group. In preferred embodiments, n=3, where R¹ includes, but is not limited to, linear hexadecyl, tetradecyl, dodecyl, decyl or octadecyl. In further embodiments, other derivatives with more variable R¹ groups can be substituted, which rely on their properties of being surface active agents (or surfactants). In one example, the structure of the surfactant of Formula 2 is:

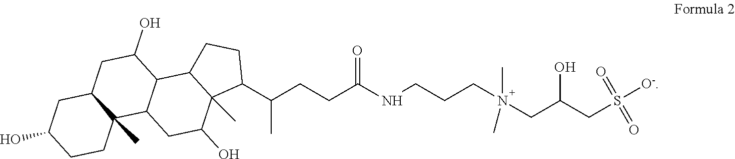

In embodiments, the hydroxy group between the quarternary ammonium group and sulfonate group can be absent without negatively affecting the antigen retrieval process for 3D histology. In another example, the identity of the zwitterionic head can be varied, as shown in the zwitterionic surfactant example of Formula 3, below:

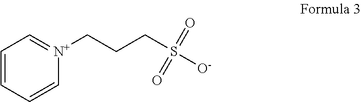 [SMILES: O=S(=O)([O-])CCC[n+]1ccccc1]

In further examples, an electrically neutral zwitterionic surfactant can be used for antigen retrieval for 3D histology. In embodiments, the zwitterionic surfactant has structure X-L1-Y-L2-Z, where X is a hydrophobic molecule independently selected from the group consisting of alkyl and aromatic chains and, optionally, with functional group decorations, e.g., N-heterocyclic groups, alkene group, or alkyne group; where Y is a cationic group independently selected from the group consisting of a quaternary ammonium group, a pyridinium group, an imidazolium group, a triazolium group, a pyrrolium group, a tetrazolium group, and a quaternary phosphonium group; where Z is an anionic group, independently selected from the group consisting of a sulfonate group, a carboxylate group, a phosphonate group, a phosphinate group, a sulfinate group, a sulfate group, and a boronate group; where L1 is an optional linker between X and Y, independently selected from the group consisting of an alkyl chain, an alkene chain, a hydroxylated alkyl chain, an aromatic chain, and an aminated alkyl chain; where L2 is a linker between Y and Z, independently selected from the group consisting of an alkyl chain, an alkene chain, a hydroxylated alkyl chain, an aromatic chain, and an aminated alkyl chain, and where the L1 and L2 alkyls can be linear, branched or cyclic.

In certain embodiments, the chaotrope may be chosen from the Hofmeister series compounds, which exhibit chaotropic properties. In some embodiments, the chaotrope includes, but is not limited to, urea, guanidinium salts, perchlorate, thiocyanate, iodide, triiodide, perrhenate, bromide, hexacyanoferrate (III) ion, hexacyanoferrate (II) ion, hexafluorophosphate, borate, tetrafluoroborate, boron cluster compounds, polyoxometallates of vanadium, molybdenum, and tungsten.

In certain embodiments, the boron cluster compounds can be derivatives of anionic boron clusters ions with 10-20 boron atoms, optionally including 0-4 non-boron atoms, such as carbon (known as carborates), or metal ions (e.g., cobalt bis(7,8-dicarbollide)). The boron atoms may be attached to a hydrogen atom, or another atom, as derivative, where different vertices of the boron cluster can be completely and/or independently derivatized. The derivatization from a hydrogen atom can be changed, for example, into a chlorine, bromine, iodine, methyl, ethyl, trifluoromethyl, hydroxyl, methoxy, ethoxy, alkoxyl, amino, cyano, cyanato, thiocyanato, isocyanato, isothiocyanato, etc.

In preferred embodiments, the boron cluster has 12 boron atoms with no other non-boron atoms, also known as closo-dodecaborate. The general structure of closo-dodecaborate is:

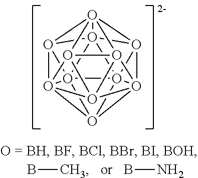

where the boron atoms are represented as spheres with different independent derivatization as indicated, where in a preferred embodiment all vertices are hydrogen-derivatized, i.e., dodecahydro-closo-dodecaborates, and where each sphere includes, but is not limited to, a group independently comprising BH, BF, BCI, BBr, BOH, B—CH₃, and B—NH₂. The counter cation for the closo-dodecaborate can be independently varied with a soluble salt, such as lithium, sodium, potassium, rubidium, cesium, calcium, magnesium, hydrogen, tri (hydroxymethyl)methylammonium, ethylenediammonim, ammonium, methylammonium, hydrazinium, ethylammonium, triethanolammonium, etc. In preferred embodiment, the counter cation is sodium.

In certain embodiments, the concentration of the zwitterionic surfactant ranges from about 0.001M-to about 0.5M. Any concentration range, or concentration, between 0.001M and 0.5M can be used. In preferred embodiments, the concentration of the zwitterionic surfactant is about 0.1M.

In embodiments, the concentration of the dodecahydro-closo-dodecaborate ion can independently range from 0.001M-0.5M. Any concentration range, or concentration, between 0.001M and 0.5M can be used. In preferred embodiments, the concentration of the dodecahydro-closo-dodecaborate ion is 0.25M.

In certain embodiments, the incubation temperature for the antigen retrieval step ranges from about 30° C. to about 80° C. In preferred embodiments, the incubation temperature for the antigen retrieval step ranges from about 45° C. to about 60° C. In more preferred embodiments, the incubation temperature for the antigen retrieval step is about 55° C.

In certain embodiments, the incubation duration of the antigen retrieval step ranges from about 10 minutes to about 2 weeks. In preferred embodiments, the incubation duration of the antigen retrieval step is equal or less than 72 hours.

In further embodiments, the aqueous solution for antigen retrieval optionally comprises an additive, for example an organic solvent, for the purpose of further solubilizing the proteins and residual paraffin wax. In certain embodiments, the organic solvent includes, but is not limited to, a water-miscible solvent such as an alcohol, ketone, ether, ester, nitrile, amide, and polar aprotic solvent. In certain examples, the organic solvent includes, but is not limited to, methanol, ethanol, isopropanol, 1,2-hexanediol, ethylene glycol, glycerol, propylene glycol, ethylene carbonate, propylene carbonate, acetone, butanone, tetrahydrofuran, 1,4-dioxane, dimethylsulfoxide, acetonitriles, dimethylacetamide, dimethylformamide, N-methylpyrrolidone, dimethylimidazolidone, dimethylpropyleneurea, hexamethylphosphoramide, pyridine, sulfolane, methylsulfonylmethane; a salt, such as a water soluble inorganic salt; a pH adjusting agent, such as an acid, a base, e.g., a buffering agent; and an ion-chelating agent, for removing unwanted cations that may change the ionic strength of the antigen retrieval solution and for preventing damage to nucleic acids. In further examples, the organic solvent, includes, but is not limited to, ethylenediamine tetraacetic acid (EDTA), citric acid, phosphonic acids, and sulfonic acids.

### Materials and Methods

For antigen retrieval in 2D sections, the first step is invariably deparaffinization, which is the process of removing physical wax from the section. This is typically done by washing the tissue in xylene or limonene, then in decreasing graded series of ethanol for gradual rehydration, before moving on to antigen retrieval.

However, such method worked only in FFPE sections but not tissue volumes extracted from wax, even with a range of optimization, combinations, and extended period of treatment. The 3D IHC quality and resulting images are still non-specific with poor or no signal.

We attribute the failures of 2D section-based deparaffinization and antigen retrieval to not addressing the volumetric effects of tissues, which complicates penetration and removal of chemicals from the tissue. In addition, 2D histology has the advantage of using signal amplification that can greatly accentuate contrasts but is inapplicable to 3D histology because it would be highly inefficient. The core problem of making antigens sensitively detectable by antibody is not fully solved with 2D antigen retrieval methods. Finally, 2D antigen retrieval methods have the luxury of spending a few slices to optimize the various antigen retrieval methods and conditions, while antigen retrieval for 3D histology is essentially one-shot because any damages may completely render the whole tissue useless. This further disfavor the use of tissue heating (typically above 80° C.), protease digestion, and denaturing detergent treatment methods that had been so successful in 2D histology.

The following is an exemplary protocol for antigen retrieval from FFPE sample for 3D IHC analysis:
(i) deparaffinizing by washing the tissue with pure cyclohexane or methylcyclopentane at room temperature (rt);
(ii) additionally washing the tissue with cyclohexane or methylcyclopentane for 0-3 times to ensure adequate deparaffinization;
(iii) washing the tissue with 85% v/v tetrahydrofuran (THF) with 15% v/v methanol (MeOH) at rt;
(iv) washing the tissue with 85:15 v/v ratio of THF:MeOH for 0-3 times to ensure complete removal of the cyclohexane or methylcyclopentane;
(v) rehydrating the tissue through graded methanol washing steps ranging from 100% MeOH to 0% MeOH in purified water at rt;
(vi) washing the tissue with purified water;
(vii) placing the tissue in a mixture of antigen retrieval solution, containing 0.1M Zwittergent® (n-alkyl-N,N-dimethyl-3-ammonio-1-propanesulfonate) and 0.25M dodecahydro-closo-dodecaborate ion in purified water and incubating the tissue at temperatures of 37-55° C. for 1 hour to 2 days, depending on the tissue size;
(viii) washing the tissue with purified water extensively at 37-55° C. for 1 minute to 1 hour 0-3 times, depending on the tissue size;
(ix) proceeding to 3D IHC of the tissue.

All patents, patent applications, provisional applications, and publications referred to or cited herein are incorporated by reference in their entirety, including all figures and tables, to the extent they are not inconsistent with the explicit teachings of this specification.

Following are examples that illustrate procedures for practicing the invention. These examples should not be construed as limiting. All percentages are by weight and all solvent mixture proportions are by volume unless otherwise noted.

### Example 1—Antigen Retrieval from FFPE Samples for 3D IHC Analysis

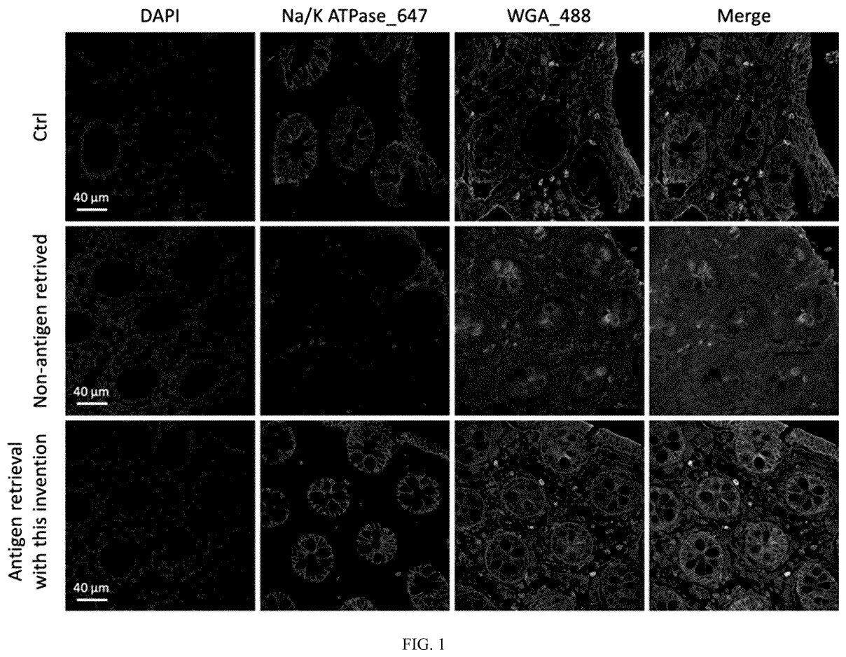

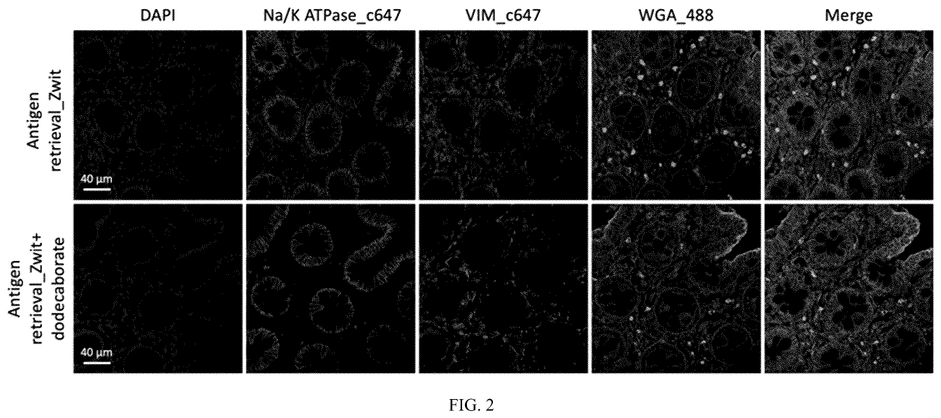

In comparison with FFPE samples with simple deparaffinization, the addition of the aqueous-based antigen retrieval solution resulted in much better 3D IHC quality. FIG. 1 shows a paired sample where a control tissue (formalin-fixed human colon tissue) was kept in PBS (without going through FFPE process), and FIG. 2 shows paired samples from the same tissue batch that were paraffin-embedded, deparaffinized, and stained with 3D IHC without and with the antigen retrieval method. The tissues that were antigen retrieved with the method of the subject invention produced superior staining quality indistinguishable with the 1^{st} control that had not been embedded in paraffin wax.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### Exemplary Embodiments

Embodiment 1. A method for antigen retrieval from formalin-fixed paraffin-embedded (FFPE) tissues for 3D IHC, comprising:
(a) obtaining an FFPE tissue;
(b) deparaffinizing the tissue with an organic solvent A;
(c) washing the tissue with an organic solvent B;
(d) rehydrating the tissue with passages in a series of graded solvent solutions;
(e) washing the tissue with purified water;
(f) retrieving antigens by placing the tissue in an aqueous detergent solution;
(g) washing the tissue with purified water; and
(h) proceeding to 3D IHC of the tissue,
wherein the organic solvent A for deparaffinizing the tissue is selected from the group consisting of saturated cyclic alkanes, and mixtures of saturated linear and cyclic alkanes;
wherein the organic solvent B for washing the tissue is selected from the group consisting of a mixture of tetrahydrofuran and methanol;
wherein the graded solvent solutions for rehydrating the tissue comprise methanol-water mixtures with decreasing concentrations of methanol, and optionally one or more additives; and
wherein the aqueous detergent solution for retrieving antigens comprises a surfactant, a chaotropic agent and, optionally, an additive.

Embodiment 2. The method of embodiment 1, wherein the graded solvent solutions optionally comprise one or more additives selected from the group consisting of surfactant S, an organic salt, an inorganic salt, an acid and base controlling agent, and an organic solvent, wherein the surfactant S is selected from the group consisting of zwitterionic surfactants, non-ionic surfactants, anionic surfactants, and cationic surfactants.

Embodiment 3. The method of embodiment 1 or 2, wherein the aqueous detergent solution optionally comprises an additive selected from the group consisting of water-miscible solvents, salts, pH adjusting agents, ion-chelating agents, and cyclodextrins.

Embodiment 4. The method of any preceding embodiment, wherein the surfactant comprises an alkylated sulfobetaine coupled with a closo-dodecaborate ion of formula [B₁₂H₁₂]²⁻, wherein the surfactant has Formula 1:

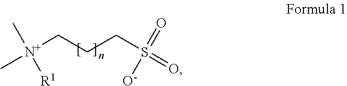

wherein n ranges from 0 to 10; wherein R¹ is independently selected from the group consisting of linear alkyl group, branched alkyl group, cyclic alkyl group, steroid-containing group, and aromatic-containing alkyl group or wherein n=3, wherein R¹ is selected from the group consisting of linear hexadecyl, tetradecyl, dodecyl, decyl and octadecyl.

Embodiment 5. The method of any preceding embodiment, wherein the surfactant has Formula 2:

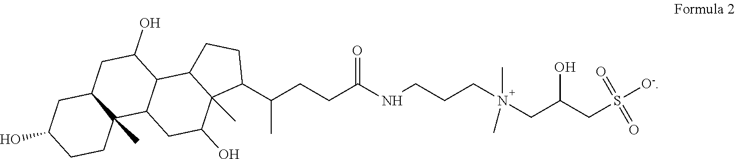

Embodiment 6. The method of any of embodiments 1-4, wherein the surfactant has Formula 3:

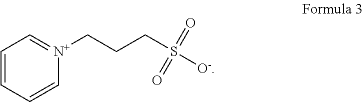

Embodiment 7. The method of any of embodiments 1-4, wherein the surfactant is a zwitterionic surfactant, wherein the zwitterionic surfactant has structure X-L1-Y-L2-Z,
wherein X is a hydrophobic group selected from the group consisting of an alkyl, an aromatic chain and, optionally, a functional group decoration selected from the group consisting of hydroxyl group, ether group, phenyl group, N-heterocyclic group, alkene group, and alkyne group,
wherein Y is a cationic group independently selected from the group consisting of quaternary ammonium, pyridinium, imidazolium, triazolium, pyrrolium, tetrazolium, and quaternary phosphonium;
wherein Z is an anionic group independently selected from the group consisting of sulfonate, carboxylate, phosphonate, phosphinate, sulfinate, sulfate, and boronate;
wherein L1 is optionally a linker between X and Y independently selected from the group consisting of alkyl, alkene, hydroxylated alkyl, aromatic chain, and aminated alkyl chain;
wherein L2 is a linker between Y and Z independently selected from the group consisting of alkyl, alkene, hydroxylated alkyl, aromatic chain, and aminated alkyl; and
wherein the L1 and L2 alkyls are selected from the group consisting of linear, branched, and cyclic.

Embodiment 8. The method of any preceding embodiment, wherein the alkylated sulfobetaine is N-hexadecyl-N,N-dimethyl-3-ammonio-1-propanesulfonate, wherein the concentration of-hexadecyl-N,N-dimethyl-3-ammonio-1-propanesulfonate is about 0.1M.

Embodiment 9. The method of any preceding embodiment, wherein the chaotrope is selected from the group consisting of urea, guanidinium salts, perchlorate, thiocyanate, iodide, triiodide, perrhenate, bromide, hexacyanoferrate (III) ion, hexacyanoferrate (II) ion, hexafluorophosphate, borate, tetrafluoroborate, and polyoxometallates of vanadium, molybdenum, and tungsten.

Embodiment 10. The method of any preceding embodiment, wherein the chaotrope is a boron cluster compound,
wherein the boron cluster compound is a derivative of anionic boron clusters ions with 10-20 boron atoms, optionally including 0-4 non-boron atoms selected from the group consisting of carbon and metal ions, wherein the boron atoms are attached to a hydrogen atom, or to a substitute atom, as derivative selected from the group consisting of carbon, nitrogen, oxygen, sulfur, chlorine, bromine, and iodine; and
wherein the vertices of the boron cluster are partially or completely derivatized, wherein the derivatized group is independently selected from the group consisting of chlorine, bromine, iodine, methyl, ethyl, trifluoromethyl, hydroxyl, methoxy, ethoxy, alkoxyl, amino, cyano, cyanato, thiocyanato, isocyanato, and isothiocyanato.

Embodiment 11. The method of embodiment 10, wherein the boron cluster compound is closo-dodecaborate having Formula 4:

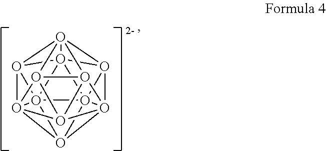

wherein each vertex is independently selected from the group consisting of BH, BF, BCI, BI, BOH, B—CH₃, and B—NH₃.

Embodiment 12. The method of embodiment 11, wherein the boron cluster compound is dodecahydro-closo-dodecaborate, wherein the counter cation for the closo-dodecaborate is independently selected from the group consisting of lithium, sodium, potassium, rubidium, cesium, calcium, magnesium, hydrogen, tri (hydroxymethyl)methylammonium, ethylenediammonim, ammonium, methylammonium, hydrazinium, ethylammonium, and triethanolammonium.

Embodiment 13. The method of embodiment 12, wherein the counter cation for the closo-dodecaborate is sodium, wherein the concentration of the sodium closo-dodecaborate is about 0.25M.

Embodiment 14. The method of any preceding embodiment, wherein the concentration of the zwitterionic surfactant ranges from about 0.001M to about 0.5M.

Embodiment 15. The method of any preceding embodiment, wherein the concentration of the dodecahydro-closo-dodecaborate ion ranges from about 0.001M to about 0.5M.

Embodiment 16. The method of any preceding embodiment, wherein the incubation temperature for the antigen retrieval step ranges from about 30° C. to about 80° C.

Embodiment 17. The method of embodiment 16, wherein the incubation temperature for the antigen retrieval step ranges from about 45° C. to about 60° C.

Embodiment 18. The method of embodiment 17, wherein the incubation temperature for the antigen retrieval step is about 55° C.

Embodiment 19. The method of any preceding embodiment, wherein the incubation duration for the antigen retrieval step ranges from about 10 minutes to about 2 weeks.

Embodiment 20. The method of embodiment 19, wherein the incubation duration for the antigen retrieval step is about 72 hours.

### REFERENCES

1. Shi S. R. et al. Antigen retrieval immunohistochemistry: review and future prospects in research and diagnosis over two decades. J Histochem Cytochem. (2011) January; 59 (1): 13-32. doi: 10.1369/jhc.2010.957191. PMID: 21339172; PMCID: PMC3201121.
2. Shi, S. R. et al. Antigen retrieval techniques: current perspectives. The journal of histochemistry and cytochemistry: official journal of the Histochemistry Society. (2001) Vol. 49, 8:931-7. doi: 10.1177/002215540104900801
3. Yau, C. N. et al. INSIHGT: an accessible multi-scale, multi-modal 3D spatial biology platform. Nature Communications (2024) 15, 10888. doi.org/10.1038/s41467-024-55248-0

We claim:

1. A method for antigen retrieval from formalin-fixed paraffin-embedded (FFPE) tissues for 3D IHC, comprising:
(a) obtaining an FFPE tissue;
(b) deparaffinizing the tissue with an organic solvent A;
(c) washing the tissue with an organic solvent B;
(d) rehydrating the tissue with passages in a series of graded solvent solutions;
(e) washing the tissue with purified water;
(f) retrieving antigens by placing the tissue in an aqueous detergent solution;
(g) washing the tissue with purified water; and
(h) proceeding to 3D IHC of the tissue,
wherein the organic solvent A for deparaffinizing the tissue is selected from the group consisting of saturated cyclic alkanes, and mixtures of saturated linear and cyclic alkanes;
wherein the organic solvent B for washing the tissue is selected from the group consisting of a mixture of tetrahydrofuran and methanol;
wherein the graded solvent solutions for rehydrating the tissue comprise methanol-water mixtures with decreasing concentrations of methanol, and optionally one or more additives; and
wherein the aqueous detergent solution for retrieving antigens comprises a surfactant, a chaotropic agent, and optionally an additive.

2. The method of claim 1, wherein the graded solvent solutions optionally comprise one or more additives selected from the group consisting of surfactant S, an organic salt, an inorganic salt, an acid and base controlling agent, and an organic solvent, wherein the surfactant S is selected from the group consisting of zwitterionic surfactants, non-ionic surfactants, anionic surfactants, and cationic surfactants.

3. The method of claim 1, wherein the aqueous detergent solution comprises an additive selected from the group consisting of water-miscible solvents, salts, pH adjusting agents, ion-chelating agents, and cyclodextrins.

4. The method of claim 1, wherein the surfactant comprises an alkylated sulfobetaine coupled with a closo-dodecaborate ion of formula [B₁₂H₁₂]²⁻, wherein the surfactant has Formula 1: 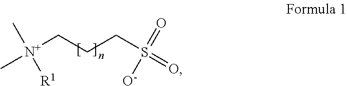
wherein n ranges from 0 to 10; wherein R¹ is independently selected from the group consisting of linear alkyl group, branched alkyl group, cyclic alkyl group, steroid-containing group, and aromatic-containing alkyl group or wherein n=3 wherein R¹ is selected from the group consisting of linear hexadecyl, tetradecyl, dodecyl, decyl and octadecyl.

5. The method of claim 4, wherein the surfactant has Formula 2:

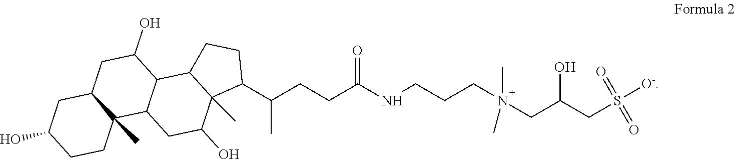

6. The method of claim 4, wherein the surfactant has Formula 3:

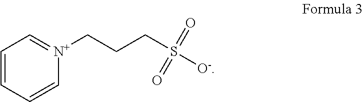

7. The method of claim 4, wherein the surfactant is a zwitterionic surfactant, wherein the zwitterionic surfactant has structure X-L1-Y-L2-Z,
wherein X is a hydrophobic group selected from the group consisting of an alkyl, an aromatic chain and, optionally, a functional group decoration selected from the group consisting of hydroxyl group, ether group, phenyl group, N-heterocyclic group, alkene group, and alkyne group,
wherein Y is a cationic group independently selected from the group consisting of quaternary ammonium, pyridinium, imidazolium, triazolium, pyrrolium, tetrazolium, and quaternary phosphonium;
wherein Z is an anionic group independently selected from the group consisting of sulfonate, carboxylate, phosphonate, phosphinate, sulfinate, sulfate, and boronate;
wherein L1 is optionally a linker between X and Y independently selected from the group consisting of alkyl, alkene, hydroxylated alkyl, aromatic chain, and aminated alkyl chain;
wherein L2 is a linker between Y and Z independently selected from the group consisting of alkyl, alkene, hydroxylated alkyl, aromatic chain, and aminated alkyl; and
wherein the L1 and L2 alkyls are selected from the group consisting of linear, branched, and cyclic.

8. The method of claim 4, wherein the alkylated sulfobetaine is N-hexadecyl-N,N-dimethyl-3-ammonio-1-propanesulfonate, wherein the concentration of N-hexadecyl-N,N-dimethyl-3-ammonio-1-propanesulfonate is about 0.1M.

9. The method of claim 4, wherein the chaotrope is selected from the group consisting of urea, guanidinium salts, perchlorate, thiocyanate, iodide, triiodide, perrhenate, bromide, hexacyanoferrate (III) ion, hexacyanoferrate (II) ion, hexafluorophosphate, borate, tetrafluoroborate, and polyoxometallates of vanadium, molybdenum, and tungsten.

10. The method of claim 4, wherein the chaotrope is a boron cluster compound,
wherein the boron cluster compound is a derivative of anionic boron clusters ions with 10-20 boron atoms, optionally including 0-4 non-boron atoms selected from the group consisting of carbon and metal ions, wherein the boron atoms are attached to a hydrogen atom, or to a substitute atom, as derivative selected from the group consisting of carbon, nitrogen, oxygen, sulfur, chlorine, bromine, and iodine; and
wherein the vertices of the boron cluster are partially or completely derivatized, wherein the derivatized group is independently selected from the group consisting of chlorine, bromine, iodine, methyl, ethyl, trifluoromethyl, hydroxyl, methoxy, ethoxy, alkoxyl, amino, cyano, cyanato, thiocyanato, isocyanato, and isothiocyanato.

11. The method of claim 4, wherein the boron cluster compound is closo-dodecaborate having Formula 4: 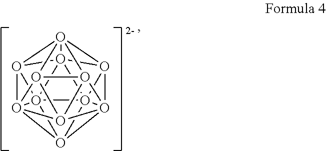
wherein each vertex is independently selected from the group consisting of BH, BF, BCI, BI, BOH, B—CH₃, and B—NH₃.

12. The method of claim 11, wherein the boron cluster compound is dodecahydro-closo-dodecaborate, wherein the counter cation for the closo-dodecaborate is independently selected from the group consisting of lithium, sodium, potassium, rubidium, cesium, calcium, magnesium, hydrogen, tri (hydroxymethyl)methylammonium, ethylenediammonim, ammonium, methylammonium, hydrazinium, ethylammonium, and triethanolammonium.

13. The method of claim 12, wherein the counter cation for the closo-dodecaborate is sodium, wherein the concentration of the sodium closo-dodecaborate is about 0.25M.

14. The method of claim 7, wherein the concentration of the zwitterionic surfactant ranges from about 0.001M to about 0.5M.

15. The method of claim 7, wherein the concentration of the dodecahydro-closo-dodecaborate ion ranges from about 0.001M to about 0.5M.

16. The method of claim 1, wherein the incubation temperature for the antigen retrieval step ranges from about 30° C. to about 80° C.

17. The method of claim 16, wherein the incubation temperature for the antigen retrieval step ranges from about 55° C. to about 60° C.

18. The method of claim 17, wherein the incubation temperature for the antigen retrieval step is about 55° C.

19. The method of claim 1, wherein the incubation duration for the antigen retrieval step ranges from about 10 minutes to about 2 weeks.

20. The method of claim 19, wherein the incubation duration for the antigen retrieval step is about 72 hours.
